(19) United States
(12) Patent Application Publication
(10) Pub. No.: US 2005/0232184 A1
(43) Pub. Date: Oct. 20, 2005

(54) Network presence updating apparatus and method

(75) Inventor: Michael Borella, Naperville, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Incorporated

(21) Appl. No.: 10/825,489

(22) Filed: Apr. 15, 2004

(51) Int. Cl. H04Q 7/00

(52) U.S. Cl. 370/328

(57) ABSTRACT

Upon detecting when a communication unit (12) becomes active in a network, and further upon determining that this communication unit became active without also simultaneously self-initiating a network presence update, another network entity (14) automatically sources a network presence update message on behalf of the communication unit. Such a message may be directed, for example, to a presence server (15). In a preferred approach, such presence updates are batched and provided to a subscribing mobile communication unit pursuant to a corresponding resource conservation strategy.

### TECHNICAL FIELD

This invention relates generally to communications and more particularly to network presence information.

### BACKGROUND

Those skilled in the art understand that “presence” relates generally to the detection and/or monitoring of access and/or accessibility of one or more communication units (and/or applications or users) with respect to a communication system or network. For example, a given communication unit's present access point within a multi-access point communication network may be noted and tracked (at least from time to time). This information can be used, for example, to appropriately source a next outbound transmission to that communication unit by permitting expedient selection of that particular access point to bear such a transmission. As used herein, “presence” will be particularly understood to include presence, availability, and location services of various types and form.

Presence servers are also known. Such servers, as a stand-alone element, as shared functionality within a given platform, or as distributed over multiple platforms typically receive published information from such entities as announce their presence and/or from presence aggregators (that collect such information as regards one or more such entities) and store such information in a database (which itself may be local or remote and stand-alone or distributed over multiple platforms). A so-called watcher entity can subscribe to such presence information for a given monitored entity in various known ways to thereby facilitate a wide variety of services and features. A push subscription approach permits the presence server to automatically notify a subscribing watcher in response to presence events of interest. A pull subscription approach permits the presence server to respond to a requesting subscribing watcher with updated presence information.

Facilitating presence information-based services in a communications network can pose particular challenges, however, and particularly so when the communications network supports wireless communications. It has been determined, for example, that a large proportion of a given wireless system's bandwidth can be consumed by the need to support presence information of various kinds (including notification, subscription, and publication traffic).

This consumption can include a need to allocate supplemental channels, which can be particularly mischievous. For example, a given communication unit may be using a fundamental channel to support a voice-over-Internet Protocol communication. When that communication unit then needs to publish its current presence or to request an update of subscribed presence information, as per a typical prior art presence protocol, that communication unit may be allocated a supplemental channel to support that message. Many systems, however, provide a so-called hang-time following the last transmission of a communication unit prior to de-allocating such a channel. Therefore, even though the communication unit may only use that supplemental channel for a brief moment, such a system will maintain that allocation of resources for some significant period of time (such as 10 to 30 seconds) before de-allocating the resource.

Presence-based services meet with considerable user acceptance and demand. Present support for such services, however, can greatly increase the overall traffic handling capacity of a system, and particularly a wireless system. These circumstances can lead to various undesired results, including insufficient system capacity to ultimately support all desired activity, denial of service or reduction in quality of service, and/or increased infrastructure and operating costs, to note a few.

### BRIEF DESCRIPTION OF THE DRAWINGS

The above needs are at least partially met through provision of the network presence updating apparatus and method described in the following detailed description, particularly when studied in conjunction with the drawings, wherein:

FIG. 1 comprises a block diagram as configured in accordance with various embodiments of the invention;

FIG. 2 comprises a flow diagram as configured in accordance with various embodiments of the invention;

FIG. 3 comprises a block diagram as configured in accordance with various embodiments of the invention; and

FIG. 4 comprises a signal flow diagram as configured in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is usually accorded to such terms and expressions by those skilled in the corresponding respective areas of inquiry and study except where other specific meanings have otherwise been set forth herein.

### DETAILED DESCRIPTION

Generally speaking, pursuant to these various embodiments, one detects when a communication unit (such as, in a preferred embodiment, a wireless communication unit) becomes active notwithstanding whether the communication unit self-initiates a network presence update or not. When the detected communication unit does not self-initiate a network presence update, one then automatically sources a network presence update message on behalf of the communication unit from an entity other than the communication unit.

In many systems, a wireless communication unit can cycle at least between a dormant mode of operation and an active mode of operation. When such a wireless communication unit shifts from the dormant mode of operation to the active mode of operation, the unit will typically transmit a signal or message to indicate this active status. Pursuant to one embodiment, such a transmission can be used to facilitate detection that the communication unit has become active. As per one embodiment, a Radio Access Network (RAN) serves to make this detection.

In a preferred approach, a Packet Data Serving Node (PDSN) responds to such detection and sources the network presence update message on behalf of the communication unit. A presence server can be the intended recipient of this update message. Pursuant to one embodiment, such a presence server can react to such an update message by automatically updating the communication unit with respect to at least some network presence information. For example, to the extent that the communication unit is a subscribing watcher, corresponding current presence information for particular presence entities can be automatically forwarded to the communication unit even though the latter did not specifically request such an update.

As a result, wireless resources are not allocated or used to request the timely provision of updated presence information to such a wireless communication while simultaneously ensuring that such a subscriber in fact becomes updated in a timely fashion. Other attributes and benefits of these and other embodiments will become more evident upon reviewing this detailed description.

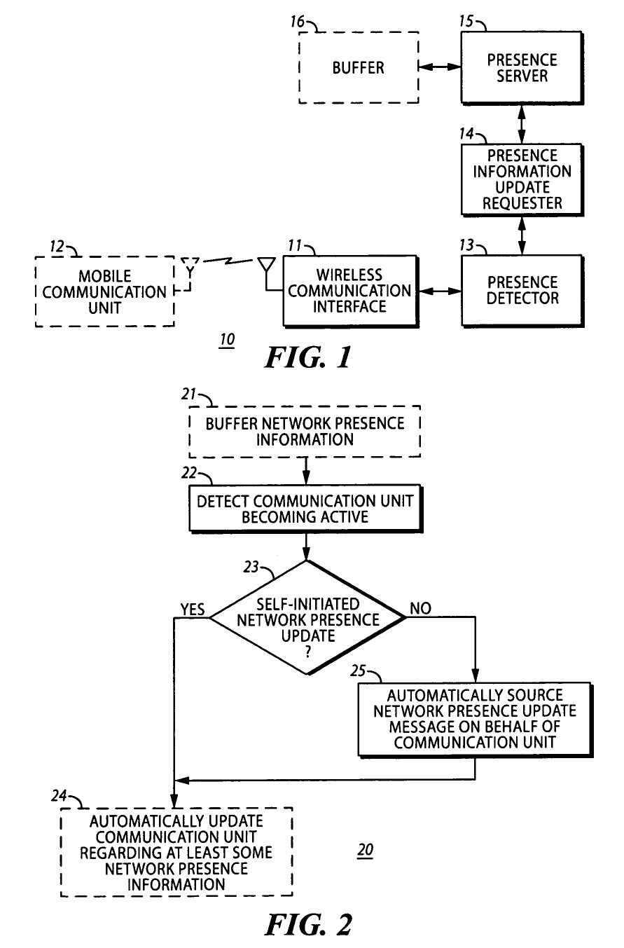

Referring now to FIG. 1, relevant elements of a communication system 10 include a wireless communication interface 11 that serves as an access point for one or more mobile communication units 12. The wireless medium can utilize any suitable technology including but not limited to radio frequency carriers or optical carriers as well as any desired modulation, coding, power control, protocol, or multiplexing scheme. Such alternatives are well known in the art and will not be related here in greater detail for the sake of brevity and clarity.

The wireless communication interface 11 operably couples to a presence detector 13 (such as, but not limited to, a Radio Access Network (RAN)) as well understood in the art. The latter operably couples to, and in particular provides a presence-detected output signal to, a presence information update requester 14 (such as, but not limited to, an appropriately configured network access server such as, but not limited to, a PDSN, a Home Location Register (HLR), an Authentication, Authorization, and Accounting element (AAA), a Serving General Packet Radio Service Support Node (SGSN), a Layer 2 Tunneling Protocol Network Server (LNS), a Packet Control Function (PCF), a Gateway General Packet Radio Service Support Node (GGSN), a Home Agent (HA), and so forth as are all well known in the art). The latter in turn operably couples to a presence server 15. Presence servers are known in the art and can comprise, as desired and/or as appropriate to the needs of a given configuration, a dedicated sole-purpose platform, a shared purpose platform, and/or a functionality that is distributed over multiple platforms. The selection of a particular architectural configuration will typically depend, at least in part, upon the needs or existing resources of a given system.

In a preferred embodiment the presence server 15 has access to presence information for various presence entities. To support such capability, the presence server 15 may have, or may have access to a buffer 16 that stores updated presence information for such presence entities. Such buffers are well understood in the art and can comprise local or remote storage facilities and can further comprise central or distributed memory as may best serve in a given context. Also depending upon the needs of a given application, such a buffer 16 can serve to retain only the most recent presence updates for some or all of the corresponding presence entities or can retain a history to a desired depth for such entities.

So configured, the presence server 15, in a preferred approach, comprises a platform to facilitate determining when to automatically provide updated presence information to a given mobile communication unit. For example, such a presence server 15 can determine when to provide such information as a function, at least in part, of a particular amount of updated presence information as is then contained in the buffer 16 (i.e., when there are at least X number of updated presence entries of interest to a given subscribing mobile communication unit, the presence server 15 can effect a batch transmission of such batched updated presence entries to the communication unit), of a particular duration of time (i.e., when an oldest item of updated presence information for a given subscribing mobile communication unit has been buffered for at least Z seconds (or other appropriate measure of time), or when a particular duration of time has passed since a last transmission of presence information) the presence server 15 can effect a similar batch transmission of such updated information), or of a predetermined level of quality of service (i.e., more frequency or more current updates may be provided to a given mobile communication unit that subscribes to a higher tier of quality of service), to name a few.

Individually and in the aggregate, these various approaches serve to provide helpful tools to a system administrator to facilitate the provision of useful and timely presence information in a communication system, including a wireless communication system, while also offering the opportunity to at least reduce system capacity requirements to support presence information handling. For example, a mobile communication unit that subscribes to presence information for other presence entities no longer needs to specifically request such information when engaging in ordinary dormant mode and active mode cycling. As another example, such a subscribing unit can remain reasonably apprised of presence information without necessarily requiring that each incremental update of such information be immediately transmitted by a presence server. Such a configuration will, in turn, permit the communication resources of a given system to be less burdened by the maintenance of presence information and to be therefore more available to support user payloads and traffic.

Referring now to FIG. 2, a general process 20 to facilitate presence-related updates (either in a system as just described or in any other appropriate supporting platform) will typically presume the availability of presence information updates from various sources (such as various communication platforms, users, and/or applications in a given communication system). As already noted, such network presence information can be optionally buffered 21 so that such information will be available for subsequent transmission. Pursuant to this process 20, one detects 22 when a communication unit becomes active (for example, when a mobile communication unit switches, for whatever reason, from a dormant state of operation to an active state of operation). Pursuant to a preferred approach, this detection 22 occurs regardless of whether the communication unit self-initiates a network presence update (that is, regardless of whether the communication unit itself requests, as a subscriber, an update regarding presence information for other presence entities supported by the network and even regardless of whether the communication unit itself specifically addresses a presence server to update its own presence information).

When the communication unit does self-initiate a network presence update, the process 20 can determine 23 to optionally automatically update 24 that communication unit with respect to at least some network presence information. For example, a presence server can transmit to the communication unit a batch transmission containing all previously buffered presence updates (for example, from other, different communication units) as are relevant to this particular communication unit. As another example, the presence server can determine, either for this initial update or for one or more subsequent updates, to continue to batch presence information updates as they arrive and to only batch transmit such updates to the communication unit as a function of update quantity or age, negotiated quality of service, and so forth as already noted above.

As to the latter, such a presence server can, for example, automatically update the communication unit with respect to buffered updated presence information when at least a predetermined number of network presence information updates have been so buffered and/or when at least one item of buffered updated presence information has been buffered for at least a predetermined period of time (such as a specific number of seconds or minutes). (It will be appreciated that the governing parameters for such approaches can be dynamically varied to suit present system loading, time of day, quality of service, and so forth. For example, a shorter duration of buffered time may be acceptable during times when system loading is minimal. Conversely, and as another example, a higher number of updates may be reasonably buffered during a time of day when traffic loading is historically heavy.)

Pursuant to at least some of these embodiments, the communication unit may not self-initiate a network presence update notwithstanding otherwise becoming active. In a preferred approach the process 20 detects 23 the absence of such a self-initiated network presence update and automatically sources 25 a network presence update message on behalf of the communication unit. Such a message will be provided, for example, to a corresponding presence server. The presence server can then optionally proceed as described above. That is, the presence server can automatically update 24 the communication unit regarding at least some network presence information. This automatic update can be conditioned or configured as appropriate to the needs of a given application and/or dynamically to suit a given sensed or anticipated context. For example, the automatic update can be provided immediately or can be delayed until at least a first predetermined condition has been satisfied (such as, for example, accumulation of a predetermined number of presence updates and/or passage of a predetermined amount of time since a predetermined event).

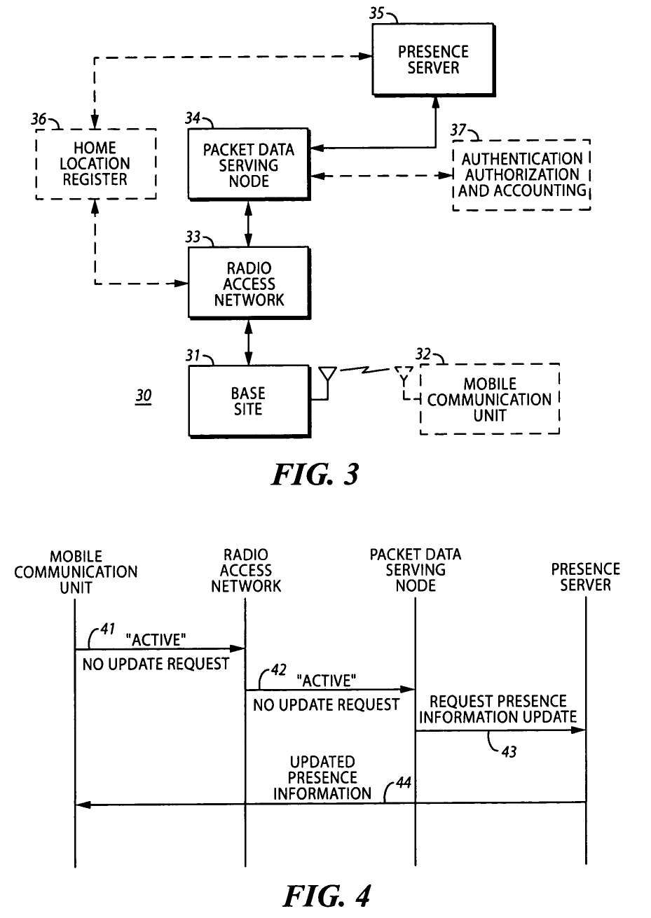

Referring now to FIG. 3, more specific embodiments will be described to support such processes. A given communication network 30 can include at least one base site 31 to serve as a wireless access point for at least one mobile communication unit 32. As already noted, essentially any wireless interface of choice can be usefully employed in conjunction with these teachings. The base site 31 in turn couples to a Radio Access Network (RAN) 33 in accordance with well understood prior art technique (where, typically, such a RAN will operably couple to a plurality of base sites and will serve to compatibly couple such base sites to one or more other intranets or extranets (including particularly the Internet)).

In a preferred embodiment, the RAN 33 operably couples to a Packet Data Serving Node (PDSN) 34, again in accord with well understood prior art practice. In a preferred approach the PDSN 34 will comprise a programmable platform that can be readily modified to support the functionality detailed above (in the alternative, of course, such functionality can be supported by a partially-programmable or a dedicated purpose/non-programmable platform, such alternatives all being well understood in the art). So configured, the PDSN 33 will preferably serve, at least in part, to receive indications that specific communication units have become active from the RAN 33. When such an indication further indicates that the corresponding communication unit has self-initiated a request for updated presence information, the PDSN 33 can simply pass that request along in ordinary course (for example, to a presence server 35) without itself specifically sourcing any additional or independent messages regarding presence information or updates.

However, and particularly to support a situation where the communication unit has not itself sourced a presence update, the PDSN 34 can respond autonomously by sourcing a message to request that an update of presence information as corresponds to the communication unit be transmitted to the communication unit when the PDSN 34 receives an indication from the RAN 33 that the communication unit has become active or has newly registered with the network. The PDSN 34 preferably directs such a message to a relevant presence server 35. In effect, the PDSN 34 automatically acts on behalf of the communication unit by requesting such updates notwithstanding that the communication unit has not itself initiated such a request.

It would be possible to support such processes without necessarily dedicating a PDSN in such a fashion (given that such a network will typically include such a network entity, however, and given that a PDSN can typically be readily configured to act in accordance with these various described processes, a PDSN-based configuration offers numerous benefits). As noted earlier, essentially any network access server, or an element flexible and programmable enough to serve in such a capacity, can be configured to accord with these teachings. Those skilled in the art will appreciate that a PDSN has only been used in an illustrative manner for the purposes of conveying the preceding description and that these inventive concepts are not limited to only that particular platform. As one illustrative example, a Home Location Register (HLR) 36 could optionally be configured in a similar fashion to support such surrogate presence update requests and to direct such requests to a presence server 35.

Many networks will already include an Authentication, Authorization, and Accounting element (AAA), and when present, such an AAA 37 will also typically operably interconnect with at least the PDSN 34. Information in the AAA 37 may be useful to support or enhance the processes set forth herein.

As one example, the AAA 37 may store presence subscription information for various communication units. When this condition prevails, a PDSN 34, upon determining that a communication unit has become active without also initiating a presence update request, could determine from the user profile that it received from the AAA 37 when the communication unit initially registered on the network to understand whether this particular communication unit has, in fact, subscribed to any relevant presence services as supported by the network. When not true, such information from the AAA 37 can be used by the PDSN 34 to facilitate modified behavior from that set forth above; that is, when a given communication unit has not subscribed to any presence services, the PDSN 34 can avoid itself sourcing a presence update request on behalf of that communication unit.

As another example, such an AAA 37 may contain information regarding a level or levels of quality of service as correspond to various communication units. Such quality of service information can be provided to the PDSN 34 (or elsewhere, such as to the presence server 35, as desired or appropriate) to permit additional response conditioning. To illustrate, for a communication unit that elects a low tier of quality of service, the PDSN 34 may elect to delay sourcing a surrogate presence update message for some period of time or until some other trigger event of choice occurs.

In the embodiments illustrated in FIG. 3, of course, the presence server 35 can respond in any of the various ways detailed above to provide the requested updated presence information. Such information, in a typically network configuration, will pass back relatively transparently through the PDSN 34 to the RAN 33 where the message is then rendered suitably configured for wireless transmission via the base site 31 to the communication unit.

Embodiments such as those supported by FIG. 3 will support a signal flow such as that illustrated in FIG. 4. In particular, when a mobile communication unit signals 41 the RAN that it has become active, the RAN forwards 42 at least a relevant portion of that content to the PDSN. The PDSN, in turn, on behalf of the communication unit, sources a request 43 for a presence information update. A presence server receives that request and responds to the communication unit with an updated presence information message 44. The mobile communication unit therefore benefits by having updated presence information without itself having had to specifically utilize additional wireless bandwidth to request such an update.

Further bandwidth conservation can be realized upon using some or all of the other teachings set forth herein regarding the buffering of presence information updates and the conditioned and tempered provision of such information to a communication unit. Such conditions can be usefully employed when scheduling an initial update in response to a surrogate-sourced update request and/or when scheduling subsequent automatic updates. Depending upon system loading, the specific conditional parameters employed, and other factors such approaches can conserve considerable network capacity and thereby permit either increased user traffic and/or obviate the need for present network capacity expansion.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

1. A method to facilitate presence-related updates, comprising:
detecting when a communication unit becomes active notwithstanding whether the communication unit self-initiates a network presence update;
automatically sourcing a network presence update message on behalf of the communication unit from an entity other than the communication unit.

2. The method of claim 1 wherein detecting when a communication unit becomes active further comprises detecting when a wireless communication unit becomes active.

3. The method of claim 2 wherein detecting when a wireless communication unit becomes active further comprises detecting, via a Radio Access Network (RAN), when the wireless communication unit becomes active.

4. The method of claim 1 wherein automatically sourcing a network presence update message on behalf of the communication unit from other than the communication unit further comprises providing the network presence update message to a presence server.

5. The method of claim 4 wherein automatically sourcing a network presence update message on behalf of the communication unit from other than the communication unit further comprises automatically sourcing the network presence update message from a Packet Data Serving Node (PDSN).

6. The method of claim 4 wherein automatically sourcing a network presence update message on behalf of the communication unit from other than the communication unit further comprises automatically sourcing the network presence update message from a network access server.

7. The method of claim 1 and further comprising:
in response to the network presence update message automatically updating the communication unit with respect to at least some network presence information.

8. The method of claim 7 wherein automatically updating the communication unit with respect to at least some network presence information further comprises sourcing the at least some network presence information from a presence server.

9. The method of claim 7 wherein automatically updating the communication unit with respect to at least some network presence information further comprises automatically updating the communication unit with respect to at least some network presence information comprising at least one item of presence information for a second, different communication unit.

10. The method of 1 and further comprising:
when the communication unit does self-initiate a network presence update, automatically updating the communication unit with respect to at least some network presence information.

11. The method of claim 1 and further comprising:
automatically buffering network presence information updates as correspond to the communication unit to provide buffered updated presence information;
automatically updating the communication unit with respect to the buffered updated presence information.

12. The method of claim 11 wherein automatically updating the communication unit with respect to the buffered updated presence information further comprises automatically updating the communication unit with respect to the buffered updated presence information when at least a predetermined number of the network presence information updates have been so buffered.

13. The method of claim 11 wherein automatically updating the communication unit with respect to the buffered updated presence information further comprises automatically updating the communication unit with respect to the buffered updated presence information when at least one item of the buffered updated presence information has been buffered for at least a predetermined period of time.

14. The method of claim 11 wherein automatically updating the communication unit with respect to the buffered updated presence information further comprises automatically updating the communication unit with respect to the buffered updated presence information when either:
at least a predetermined number of the network presence information updates have been so buffered; and
at least one item of the buffered updated presence information has been buffered for at least a predetermined period of time.

15. A system to facilitate maintaining at least relatively current presence information at a mobile communication unit, comprising:
a wireless communication interface having a two-way wireless link with the mobile communication unit at least from time to time;
a presence detector that is operably coupled to the wireless communication interface and having a mobile communication unit presence-detected output that provides a presence-detected output signal regardless of whether the mobile communication unit has requested an update of presence information;
a presence server;
a presence information update requester that is operably coupled to the mobile communication unit presence-detected output of the presence detector and having a mobile communication unit presence information request output operably coupled to the presence server.

16. The system of claim 15 wherein the presence detector comprises a Radio Access Network (RAN).

17. The system of claim 16 wherein the presence information update requester comprises a network access server.

18. The system of claim 17 wherein the network access server comprises at least one of a Packet Data Serving Node (PDSN) and a Home Location Register (HLR).

19. The system of claim 15 wherein the presence server further comprises update means responsive to the mobile communication unit presence information request output for automatically providing updated presence information to the mobile communication unit.

20. The system of claim 19 wherein the update means further comprises a buffer having at least one recent item of updated presence information.

21. The system of claim 20 wherein the update means further comprises decision means for determining when to automatically provide the updated presence information to the mobile communication unit.

22. The system of claim 21 wherein the decision means determines when to automatically provide the update presence information to the mobile communication unit as a function, at least in part, of at least one of:
an amount of updated presence information as is contained in the buffer;
a duration of time; and
a predetermined level of quality of service.

23. The system of claim 22 wherein the duration of time comprises a duration of time as corresponds to an oldest item of updated presence information as is contained in the buffer.

24. The system of claim 22 wherein the duration of time comprises a duration of time as corresponds to a last transmission of updated presence information to the mobile communication unit.

25. A method comprising:
at a Packet Data Serving Node (PDSN):
receiving an indication that a communication unit has become active, which indication does not indicate that the communication unit has also requested an update of presence information;
automatically sourcing a message to request that an update of presence information as corresponds to the communication unit be transmitted to the communication unit.

26. The method of claim 25 wherein receiving an indication that a communication unit has become active further comprises receiving the indication from a Radio Access Network (RAN).

27. The method of claim 25 wherein automatically sourcing a message further comprises automatically sourcing a message to a presence server.

28. The method of claim 25 wherein receiving an indication that a communication unit has become active further comprises receiving an indication that a wireless communication unit has become active.

29. A method comprising:
at a network access server:
receiving an indication that a communication unit's presence status has changed, which indication does not indicate that the communication unit has also requested an update of presence information;
automatically sourcing a message to request that an update of presence information as corresponds to the communication unit be transmitted to the communication unit.

30. The method of claim 29 wherein receiving an indication that a communication unit's presence status has changed further comprises receiving the indication from a Radio Access Network (RAN).
